(19) United States
(12) Patent Application Publication
(10) Pub. No.: US 2014/0049020 A1
(43) Pub. Date: Feb. 20, 2014

(54) INSERT FOR ADJUSTMENT OF OPERATIONAL CHARACTERISTIC OF A BICYCLE AND BICYCLE PORTION WITH INSERT

(71) Applicants: Martin Andreas Wendt, Bethel, CT (US); John M. Cramer, Fairfield, CT (US)

(72) Inventors: Martin Andreas Wendt, Bethel, CT (US); John M. Cramer, Fairfield, CT (US)

(73) Assignee: CYCLING SPORTS GROUP, INC., Bethel, CT (US)

(21) Appl. No.: 13/586,347

(22) Filed: Aug. 15, 2012

(51) Int. Cl. B62K 19/30; B62K 3/02; B62M 1/02

(52) U.S. Cl. 280/259; 280/274; 280/288; 280/288.4

(57) ABSTRACT

An insert for a bicycle has a central portion and a contiguous outer portion to form a unitary elongated body, the body being dimensionable by reference to major and minor datum lines, the outer portion forming a flange. The body includes a first outer surface defined by the central portion, and a second opposing outer surface defined by the central portion and the outer portion. The central portion includes a through-hole that extends perpendicularly through the body from the first outer surface to the second outer surface, wherein the hole defines a hole axis. The central portion has a non-circular outer profile that encloses the hole axis, and the flange has a non-circular outer profile that encloses the hole axis, the outer profile of the flange being larger than the outer profile of the central portion. The hole is disposed asymmetric with respect to the minor datum line.

### BACKGROUND OF THE INVENTION

The present disclosure relates generally to bicycles, and particularly to inserts for adjusting an operational characteristic of a mechanical member of the bicycle.

Some bicycle frames include rear axle dropout slots to provide for chain tension adjustment by adjusting the fore and aft position of the rear wheel axle. To make such an adjustment, the rider must loosen the rear axle bolt, slide the rear axle fore or aft to the desired position, and then retighten the bolt. To prevent inadvertent slippage of the rear axle in the slot, the rear axle bolt must be tightened to a specified torque. Some bicycle frames include two distinct dropout slots at the front fork for effectively changing the angle of the head tube by adjusting the fore and aft position of the front wheel axle, which is often used to vary the handling characteristics of the bike; a steeper effective head angle provides for faster handling and a more responsive feel during technical street riding, and a shallower effective head angle provides for a slacker feel for dirt jumping. To make such an adjustment, the rider must loosen the front axle bolt, slide the front axle onto the other dropout slot, and then retighten the bolt. To prevent inadvertent slippage of the front axle in the slot, the front axle bolt must be tightened to a specified torque. Bicycle frames that provide for adjustability allow a rider to change the bicycle's handling characteristics without changing to a completely different frame. However, ensuring that an adjustment is properly made without the risk of slippage requires that careful attention be paid to the specified torque requirements for the associated hardware, and even when such specified torque requirements are adhered to, uncontrollable shock to the bicycle during various riding conditions may cause inadvertent slippage nonetheless.

Accordingly, there remains a need in the art for bicycles having adjustability of an operational characteristic of a mechanical member of the bicycle without risk of slippage of the member being adjusted.

### BRIEF DESCRIPTION OF THE INVENTION

An embodiment includes an insert for a bicycle having a central portion and a contiguous outer portion to form a unitary elongated body, the body being dimensionable by reference to at least one of a major and minor datum line, the outer portion forming a flange. The body includes a first outer surface defined by the central portion, and a second opposing outer surface defined by the central portion and the outer portion. The central portion includes a through-hole that extends perpendicularly through the body from the first outer surface to the second outer surface, wherein the hole defines a hole axis. The central portion has a non-circular outer profile that encloses the hole axis, and the flange has a non-circular outer profile that encloses the hole axis, the outer profile of the flange being larger than the outer profile of the central portion. The hole is disposed asymmetric with respect to the minor datum line.

An embodiment includes a portion of a bicycle having a frame that includes a front portion and a rear portion attached to the front portion, the front portion having a head tube, and the rear portion having a rear wheel mount. The front fork is pivotally supported by the head tube, the front fork having a front wheel mount. At least one of the rear wheel mount and the front wheel mount includes an elongated opening, the elongated opening being enclosed around its perimeter by a constraining surface, the elongated opening being dimensionable by reference to at least a major datum line and a minor datum line. The major datum line of the rear wheel mount is oriented more horizontal than vertical with respect to a line of force of gravity when the portion of the bicycle is oriented for riding, and the major datum line of the front wheel mount is oriented more vertical than horizontal with respect to a line of force of gravity when the portion of the bicycle is oriented for riding. An elongated insert is disposed within and constrained around its perimeter by the constraining surface of the elongated opening, such that the elongated insert has only one-degree-of-freedom with respect to the elongated opening.

An embodiment includes a portion of a bicycle that has a frame having a front portion and a rear portion attached to the front portion, the front portion having a head tube, and the rear portion having a rear wheel mount. A front fork is pivotally supported by the head tube, the front fork having a front wheel mount. The front wheel mount includes an elongated opening, the elongated opening being enclosed around its perimeter by a constraining surface, the elongated opening being dimensionable by reference to at least a major datum line and a minor datum line. The major datum line of the front wheel mount is oriented more vertical than horizontal with respect to a line of force of gravity when the portion of the bicycle is oriented for riding. An elongated insert is disposed within and constrained around its perimeter by the constraining surface of the elongated opening, such that the elongated insert has only one-degree-of-freedom with respect to the elongated opening.

An embodiment includes a portion of a bicycle that has a frame having a front portion and a rear portion attached to the front portion, the front portion having a head tube, and the rear portion having a rear wheel mount, the frame further including a bottom bracket shell fixedly disposed with respect to the front and rear portions. A front fork is pivotally supported by the head tube, the front fork having a front wheel mount. A crankset is rotationally disposed with respect to the bottom bracket shell, the crankset including a spindle and a crank arm having a first end adjustably connectable to the spindle and a second opposing end configured to receive a pedal. The first end of the crank arm includes an elongated opening oriented lengthwise between the first end and the second end of the crank arm. An elongated insert is disposed within and constrained around its perimeter by the constraining surface of the elongated opening, such that the elongated insert has only one-degree-of-freedom with respect to the elongated opening. The crank arm is fixedly and adjustably connected to the spindle via the elongated insert.

### BRIEF DESCRIPTION OF THE DRAWINGS

Referring to the exemplary non-limiting drawings wherein like elements are numbered alike in the accompanying Figures:

FIG. 1 depicts a right side view of a style of BMX (Bicycle Motocross) bicycle for use in accordance with an embodiment of the invention;

FIG. 2 depicts a right side view of a style of commuter bicycle for use in accordance with an embodiment of the invention;

FIG. 3 depicts a right side view of a style of mountain bicycle for use in accordance with an embodiment of the invention;

FIG. 4 depicts a right side perspective view of a bicycle frame in accordance with an embodiment of the invention;

FIG. 5 depicts a left side perspective view of a rear dropout portion of the bicycle frame of FIG. 4;

FIG. 6 depicts isometric and orthogonal views of an elongated insert for a rear dropout in accordance with an embodiment of the invention;

FIG. 7 depicts a plurality of side views of alternative through-hole locations for the insert of FIG. 6;

FIG. 8 depicts a side perspective view of an alternative insert to that of FIG. 6 that includes a derailleur hanger;

FIG. 9 depicts a front perspective view of a front fork with an enhanced portion of a mounting plate in accordance with an embodiment of the invention;

FIG. 10 depicts isometric and orthogonal views of an elongated insert for a front fork dropout in accordance with an embodiment of the invention;

FIG. 11 depicts a side view of a mounting plate for a front fork dropout in accordance with an embodiment of the invention;

FIG. 12 depicts an isometric view of an elongated insert for the mounting plate of FIG. 11 in accordance with an embodiment of the invention;

FIG. 13 depicts in block diagram form a crank arm and insert in accordance with an embodiment of the invention; and

FIG. 14 depicts an isometric view of a crank arm and insert consistent with that of FIG. 13 in accordance with an embodiment of the invention.

### DETAILED DESCRIPTION OF THE INVENTION

Although the following detailed description contains many specifics for the purposes of illustration, anyone of ordinary skill in the art will appreciate that many variations and alterations to the following details are within the scope of the invention. Accordingly, the following embodiments of the invention are set forth without any loss of generality to, and without imposing limitations upon, the claimed invention.

An embodiment of the invention, as shown and described by the various figures and accompanying text, provides an insert for adjusting an operational characteristic of a bicycle, and a bicycle having such an insert. In an embodiment, the adjustable operational characteristic pertains to adjustment of the chain tension by removing and replacing a dropout insert with a new insert that adjusts the fore and aft location of the rear axle with respect to the crank spindle axis. In another embodiment, the adjustable operational characteristic pertains to adjustment of the head tube angle and bottom bracket height by removing and replacing a front fork insert that adjusts the elevation of the front fork relative to a horizontal plane representative of the ground when the bicycle is in a riding state. In another embodiment, the adjustable operational characteristic pertains to adjustment of the functional crank arm length by removing and replacing a crank arm insert that adjusts the functional length of the crank arm relative to the crank spindle axis. While embodiments described herein may depict a particular style of bicycle, such as a BMX (Bicycle Motocross) bicycle for example, it will be appreciated that the disclosed invention is also applicable to other styles of bicycles, such as a commuter bike, a mountain bike or a road bike, for example.

A common feature found in the above-noted inserts is the elongated geometry of the insert, where the insert may be disposed in a first orientation or in a second orientation into a mating elongated opening of a bicycle member, where the insert is rotated 180-degrees about an axis of a hole through the insert between the first orientation and the second orientation.

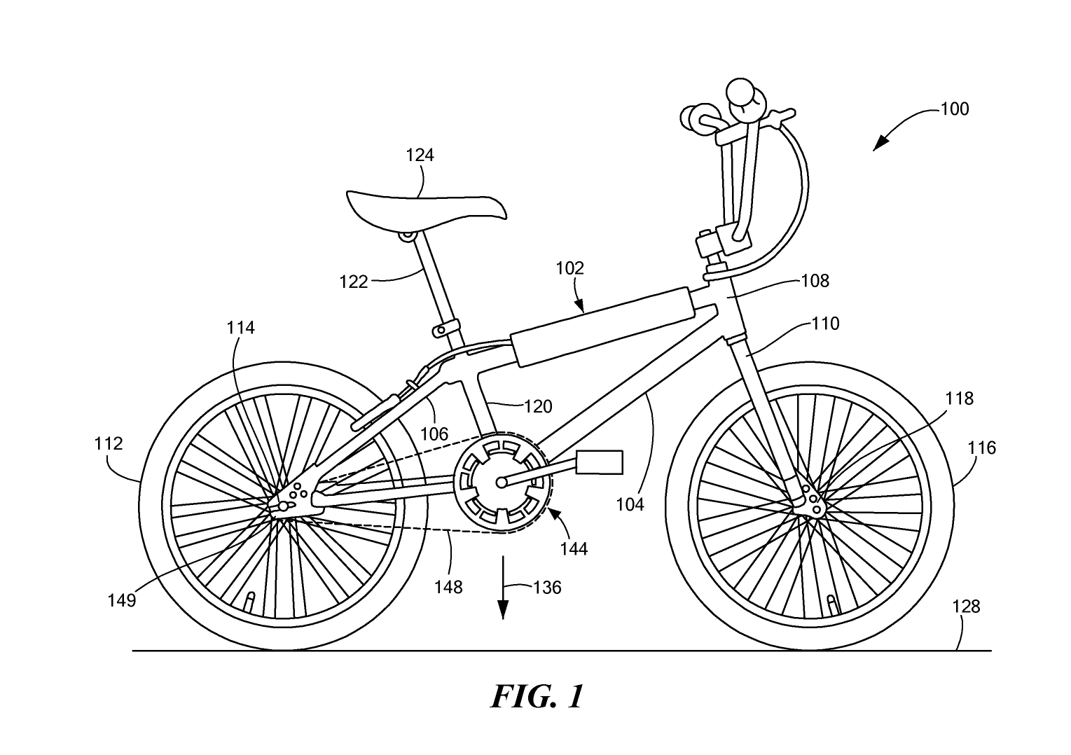

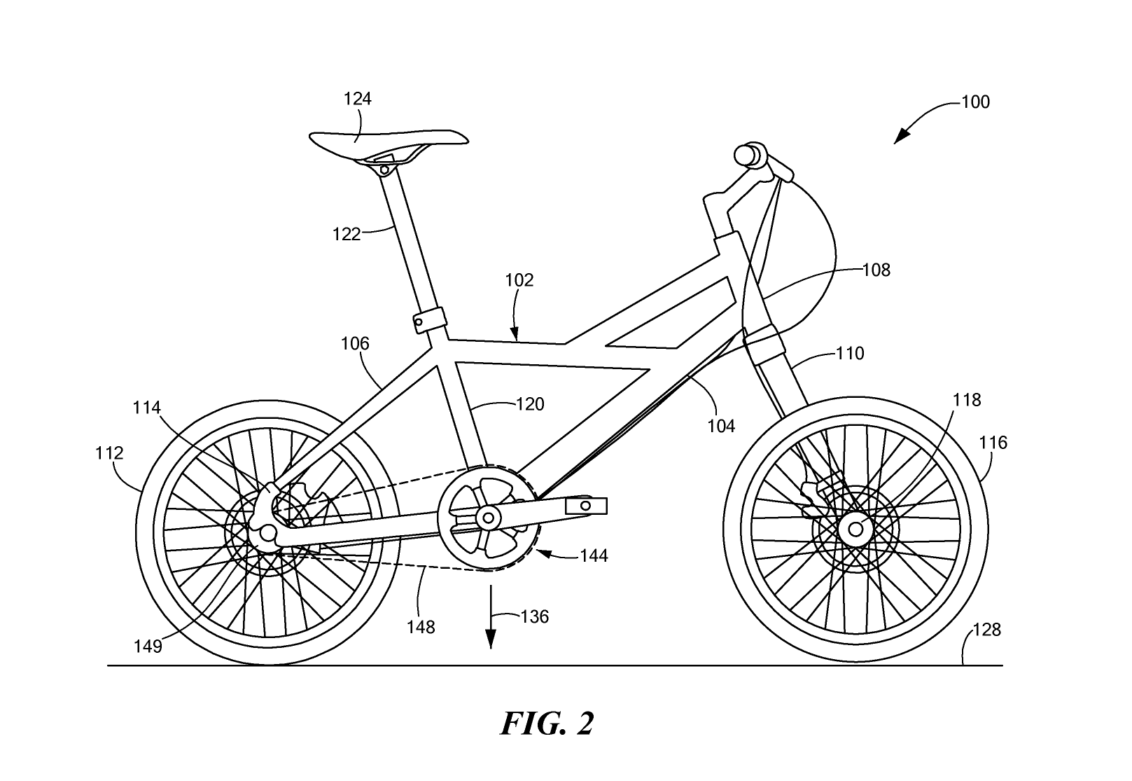

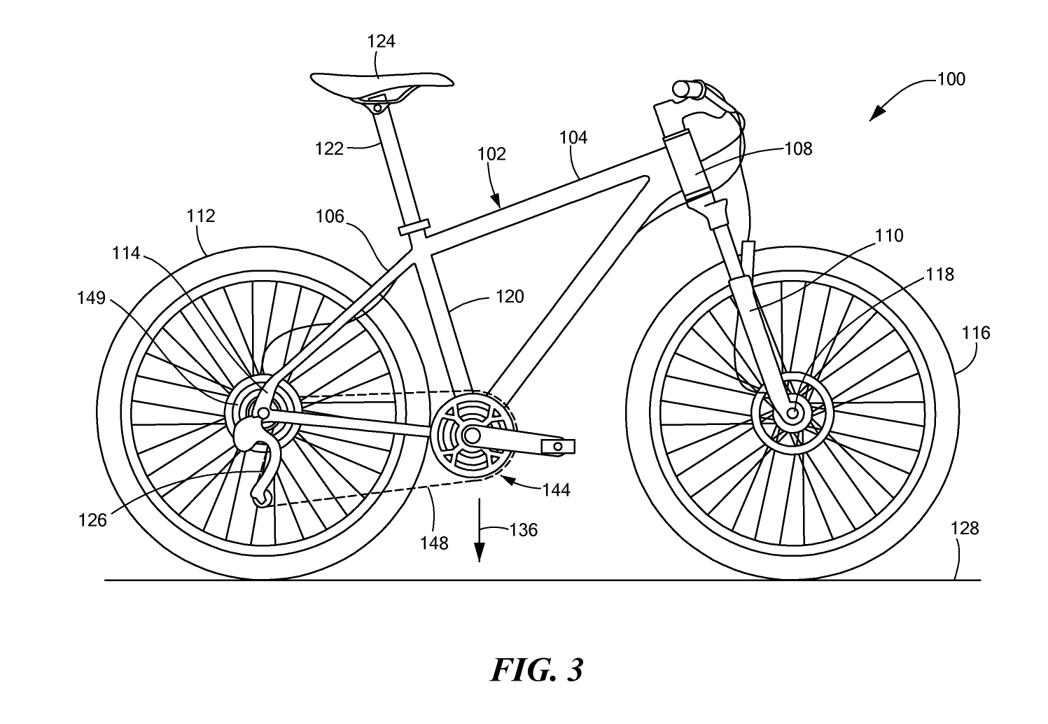

FIG. 1 depicts a BMX bike 100 having a frame 102 that includes a front portion 104 and a rear portion 106 fixedly attached to the front portion 104. The front portion 104 includes a head tube 108 that pivotally supports a front fork 110. A rear wheel 112 is pivotally supported by a rear wheel mount 114 that is part of the rear portion 106, and a front wheel 116 is pivotally supported by a front wheel mount 118 that is part of the front fork 110. A seat tube 120 forms part of the frame 102 and is fixedly joined to both the front portion 104 and the rear portion 106. The seat tube 120 may be referred to as being part of the front portion 104 or the rear portion 106. A seat post 122 slideably engages with the seat tube 120, and supports a seat 124. A crank, spider and chain ring assembly 144 is pivotally supported by a bottom bracket shell 146 of the frame 102 (the bottom bracket shell 146 is best seen with reference to FIG. 3). A drive chain 148 engages between the chain ring of the crank, spider and chain ring assembly 144, and a rear sprocket 149 (best seen with reference to FIG. 2) of the rear wheel 112. While reference may occasionally be made herein to a front “fork”, the term “fork” is not intended to be limited to just a two-pronged front wheel support structure, but is also intended to include other types of front wheel support structures, such as a “single-sided” front wheel support, for example. Note that FIG. 1 illustrates a “two sided” front wheel support, and FIG. 2 illustrates a “left-single-sided” front wheel support arrangement, which has a front wheel support structure represented by reference numeral 110 on one side, the left side, of the front wheel 116.

FIG. 2 depicts a commuter style bike 100 where like elements are number alike.

FIG. 3 depicts another style of bike referred to as a mountain bike 100, but for purposes disclosed herein may also be referred to by reference numeral 100. Like elements between FIGS. 1, 2 and 3 are numbered alike. In comparing FIGS. 1, 2 and 3, of particular interest is the front fork 110 of FIGS. 1 and 3, which illustrate a two-pronged front wheel support structure that supports the front wheel 116 via a front wheel mount 118 disposed on both sides of the front wheel 116, as compared to the left-single-sided fork of FIG. 2 having a front wheel mount 118 disposed on just one side of the front wheel 116. Of further particular interest is the rear wheel mount 114 of FIG. 3, which not only supports the rear wheel 112, but also supports a rear derailleur arm 126 that provides for use of a set of derailleur gears, as compared to the rear wheel mount 114 of FIGS. 1 and 2 having a rear wheel mount 114 configured for supporting the rear wheel 112 with a single gear arrangement. The rear and front wheel mounts 114, 118 will be discussed in more detail below.

When oriented for riding, the bike 100 sits upright with respect to a horizontal plane 128 representative of the ground.

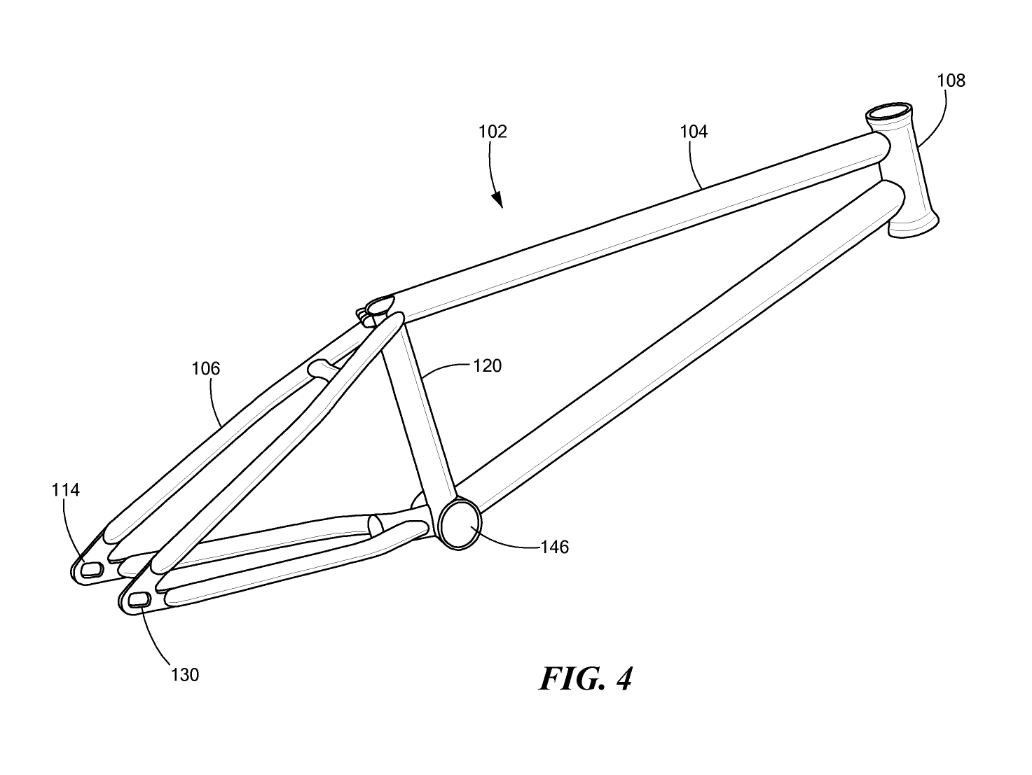

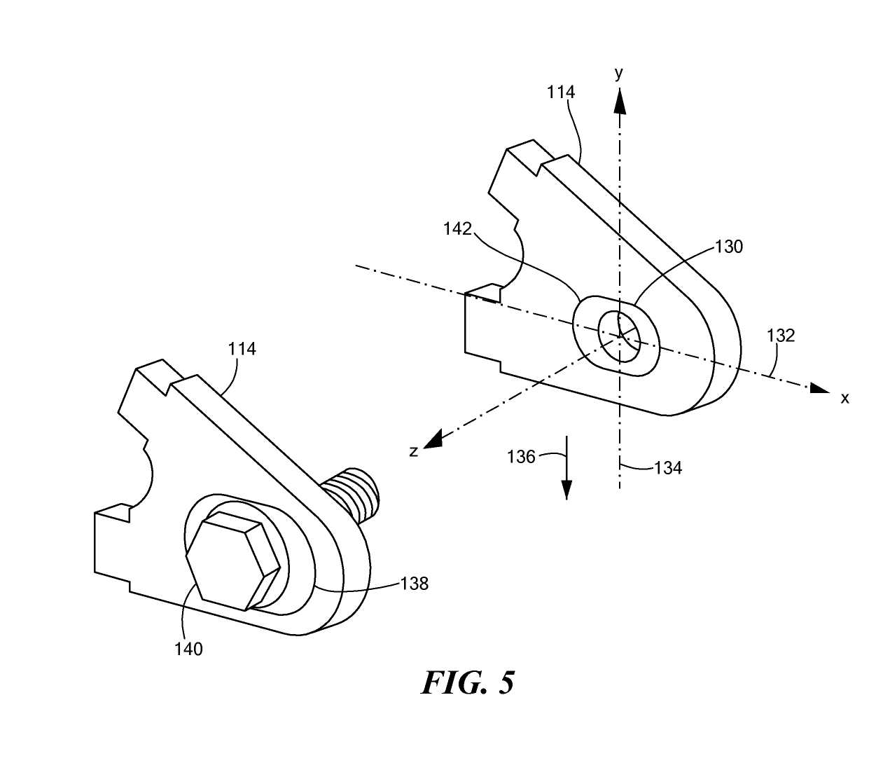

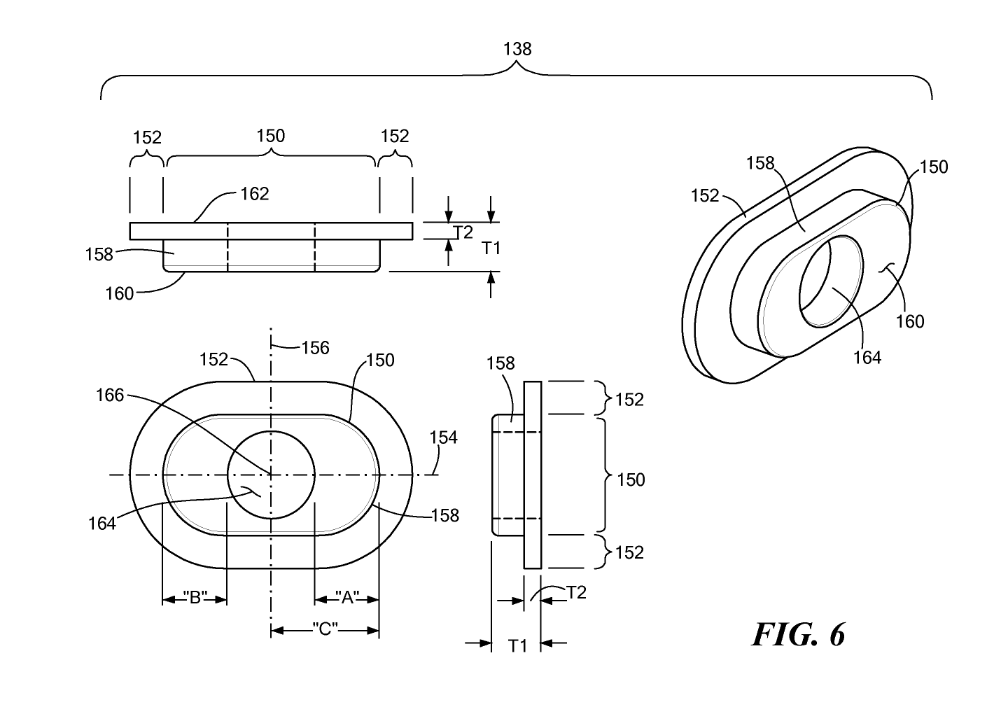

FIG. 4 depicts a bicycle frame 102 similar to that depicted in FIG. 3, where like elements are numbered alike. Of particular interest in FIG. 4 is the rear wheel mount 114, which can be seen having an elongated opening 130. A closer perspective of the rear wheel mount 114 with elongated opening 130 is depicted in FIG. 5, which also depicts a major datum line 132 and a minor datum line 134 from which the elongated opening 130 may be dimensionally defined with respect to other features of the rear wheel mount 114. The major datum line 132 is oriented lengthwise with the length of the elongated opening 130, and the minor datum line 134 is oriented widthwise with the width of the elongated opening 130. The major datum line 132 is oriented perpendicular with the minor datum line 134. The major datum line 132 and lengthwise orientation of the elongated opening 130 are oriented more horizontal than vertical with respect to a line of force of gravity 136 when the bicycle 100 is oriented for riding on a horizontal ground plane 128, which can be seen with reference to FIGS. 1, 2, 3 and 5 in combination. Further depicted in FIG. 5 is an elongated insert 138 that is held in place within the elongated opening 130 via hardware 140 that fastens to the axle of the rear wheel 112. The elongated opening 130 is enclosed around its perimeter by a constraining surface 142 formed by material of the rear wheel mount 114. The constraining surface 142 serves to fixedly constrain the elongated insert 138 in both horizontal and vertical directions, as viewed in relation to the major and minor datum lines 132, 134, thereby constraining the insert 138 to have unconstrained movement with only one-degree-of-freedom with respect to a three-dimensional orthogonal axis reference system, denoted via (x, y, z) in FIG. 5, with the one-degree-of-freedom being along the z-axis. The insert 138 will now be discussed in more detail with reference to FIG. 6.

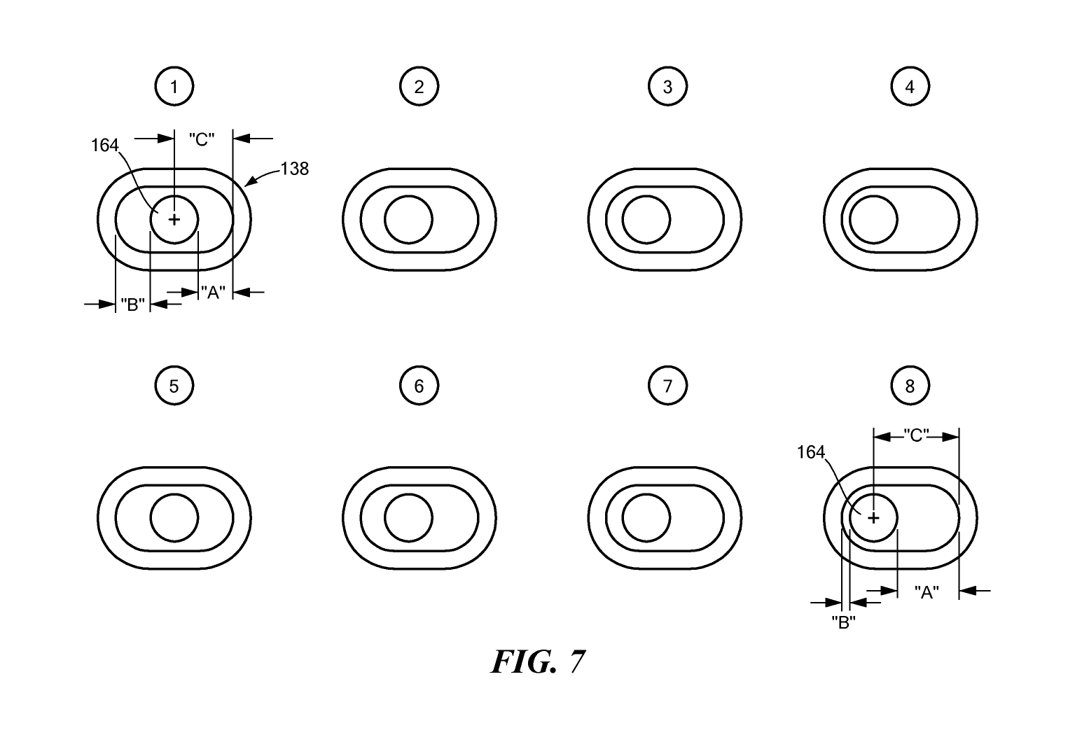

In FIG. 6, a more detailed illustration of the elongated insert 138 is depicted with reference to a single perspective view and three orthogonal views. In an embodiment, the elongated insert 138 includes a central portion 150 and an outer portion 152 that is contiguous with the central portion 150 to form a unitary elongated body, which is referred to by reference to reference numeral 138. Features of the body 138 are dimensionable by reference to a major datum line 154 and a minor datum line 156, and by reference to thicknesses T1, T2 of the central and outer portions 150, 152, respectively. The outer portion 152 forms a flange of the body 138 having a thickness T2, the outer profile of the flange being larger than the outer profile of the central portion 150. As used herein, the term profile means the outline of such feature as viewed from the perspective of the plan view illustration of the elongated insert as depicted in FIG. 7, which is discussed further below. When comparing FIG. 6 with FIG. 5, the major and minor datum lines 154, 156 of the elongated insert 138 are aligned with the major and minor datum lines 132, 134 of the elongated opening 130 of the rear wheel mount 114 when the insert 138 is disposed within the opening 130. The opening 130 of the rear wheel mount 114 may be stepped on an outboard surface so the flange 152 sits within the stepped area, or may not be stepped so the flange 152 sits proud of an outer surface of the rear wheel mount 114. An outer surface 158 of the central portion 150 is sized to fit snugly within and to be fixedly constrained in two dimensions (one-degree-of-freedom) by the constraining surface 142 surrounding the hole 130 of the rear wheel mount 114. When held in place by the hardware 140, the elongated insert 138 is constrained in three dimensions (zero-degree-of-freedom).

The body of the elongated insert 138 has a first outer surface 160 defined by the central portion 150, and a second opposing outer surface 162 defined by a combination of the central portion 150 and the outer portion 152. In an embodiment, the first outer surface 160 is planar and parallel with the second opposing outer surface 162, which is also planar. However, from the disclosure provided herein, it will be appreciated that while the first and second outer surfaces 160, 162 may be planar, they need not be planar, which will be discussed further below. The central portion 150 of the elongated insert 138 has a through-hole 164 that extends perpendicularly through the body from the first outer surface 160 to the second outer surface 162. The center of the through-hole 164, with respect to the major and minor datum lines 154, 156, defines a hole axis that may or may not coincide with the intersection 166 of the major and minor datum lines 154, 156, which will be discussed in more detail below. As illustrated in FIG. 6, the hole axis is visually illustrated so that it coincides with the intersection 166 (FIG. 7 discussed below shows variations where the hole axis does not coincide with the intersection 166). As illustrated in FIG. 6, the central portion 150 of the elongated insert 138 has a non-circular oval-like outer profile that encloses the hole axis of through-hole 164, and the flange 152 has a non-circular oval-like outer profile that encloses the hole axis of through-hole 164. As used herein, the term encloses means encloses, circumscribes or surrounds, as viewed from the perspective of the plan view illustration of the elongated insert as depicted in FIG. 7, which is discussed further below. As further illustrated in FIG. 6, the central portion 150 of the elongated insert 138 is thicker than the outer portion (flange) 152. The central portion 150, as discussed herein, is used to position the through-hole 164 relative to the frame 102 when the central portion 150 of the elongated insert 138 is disposed within the elongated opening 130.

Referring now to FIG. 7, eight separate plan views of the elongated insert 138, similar to the one plan view depicted in FIG. 6 (see lower left image of the set of three orthogonal images in FIG. 6), are depicted. Each plan view of FIG. 7 is designated by a circled number, circle-1 through circle-8, and each plan view illustrates a different location for the through-hole 164 as indicated by reference dimensions “A” and “B”, which represent right and left, respectively, edge-of-hole to edge-of-central-portion dimensions, and dimension “C”, which represents a center-of-hole to right-edge-of-central-portion dimension. While only two plan views of FIG. 7 include reference numerals, “A”, “B” and “C” dimensional references, and circle-1 and circle-8 plan views, it will be appreciated that the same description provided herein applies to all eight plan views of FIG. 7. Table-1 below provides a set of dimensions, expressed in millimeters, for the “A”, “B” and “C” dimensional references depicted in FIG. 7.

TABLE 1

| Dim-A | Dim-B | Dim-C |
|---|---|---|
| 7.0 | 6.0 | 11.85 |
| 8.0 | 5.0 | 12.85 |
| 9.0 | 4.0 | 13.85 |
| 10.0 | 3.0 | 14.85 |
| 6.5 | 6.5 | 11.35 |
| 7.5 | 5.5 | 12.35 |
| 8.5 | 4.5 | 13.35 |
| 9.5 | 3.5 | 14.35 |

As can be seen with reference to Table-1 in combination with FIGS. 6 and 7, several configurations of insert 138 includes hole 164 being disposed asymmetric with respect to the minor datum line 156. That is, several configurations of insert 138 includes hole 164 being located off of the minor datum line 156 and biased to one end of the insert 138. With such a variety of hole placements, the elongated insert 138 provides for a variety of adjustments for the location of the axle of the rear wheel 112 relative to the bottom bracket shell 146, and hence relative to the crank, spider and chain ring assembly 144, since the elongated insert 138 may be installed into the elongated opening 130 in a first orientation or a second orientation that is 180-degrees rotated about the hole axis from the first orientation. Such adjustments provide for fine-tune adjustment of not only the chain tension of the drive chain 148, but also the wheel base between the front and rear wheels 116, 112, while fixedly positioning the axle of the rear wheel 112 to prevent slippage and loss of chain tension or slippage and alteration of wheel base. That is, the location of the elongated insert 138 relative to the frame 102 is fixed with one-degree-of-freedom once the elongated insert 138 is positioned within the elongated opening 130, the insert location with one-degree-of-freedom is not dependent upon a tightening torque of a piece of hardware. In an embodiment, an end user would be supplied with a number of and a variety of inserts 138 that would enable fine tune adjustment of the bicycle chain tension or wheel base as riding conditions may require. In another embodiment, an end user would be supplied with one or more elongated inserts 138 each having two or more holes offset from and parallel to each other, which will be discussed further below.

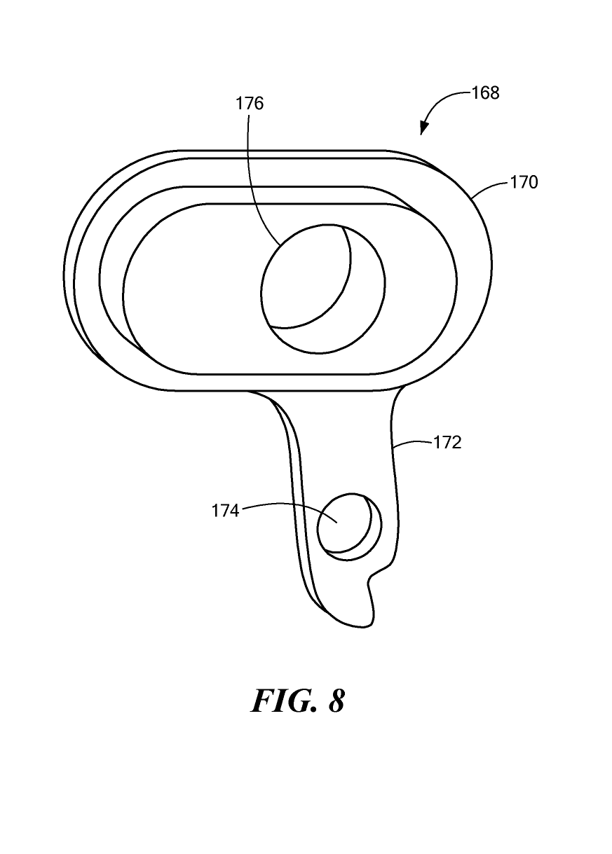

Reference is now made to FIG. 8, which depicts an elongated insert 168 having a main body 170 dimensionally similar to the main body of the elongated insert 138 so that the insert 168 may also may fit within the elongated opening 130 for the purpose discussed above, but further including an integrally formed derailleur hanger 172 having a hole 174 for supporting the derailleur arm 126 discussed above in connection with FIG. 3. The hole 176 of the insert 168 has the same function as the hole 164 of the insert 138, and in an embodiment may be disposed in one of several locations as indicated by FIG. 7. In an embodiment, an end user would be supplied with both inserts 138 and 168, so that they could easily and quickly convert any single-speed bike, such as a BMX bike of FIG. 1, a commuter bike of FIG. 2, a mountain bike of FIG. 3, or any other style of bike that may be contemplated and falling within the scope of the invention disclosed herein, into a multi-speed bike having a derailleur gear set (see FIG. 3 for example). In another embodiment, an end user is supplied with only insert 168 or with only a variety of inserts 138, such that an “out of the box” bicycle would be limited to single-speed use or multi-speed use, where the option to convert from single-speed to multi-speed, or vice versa, would be left to an aftermarket purchase of inserts 138, 168 by the end user. While the derailleur arm 126 is typically spring loaded to provide chain tension, it is contemplated that an end user could be supplied with a number of and a variety of inserts 168 that would enable further adjustment of either the bicycle chain tension or wheel base as riding conditions may require on a bicycle having a derailleur arm 126. It is also contemplated that an end user could be supplied with one or more elongated inserts 168 each having two or more holes 176 offset from and parallel to each other for chain tension or wheel base adjustment with a single insert 168.

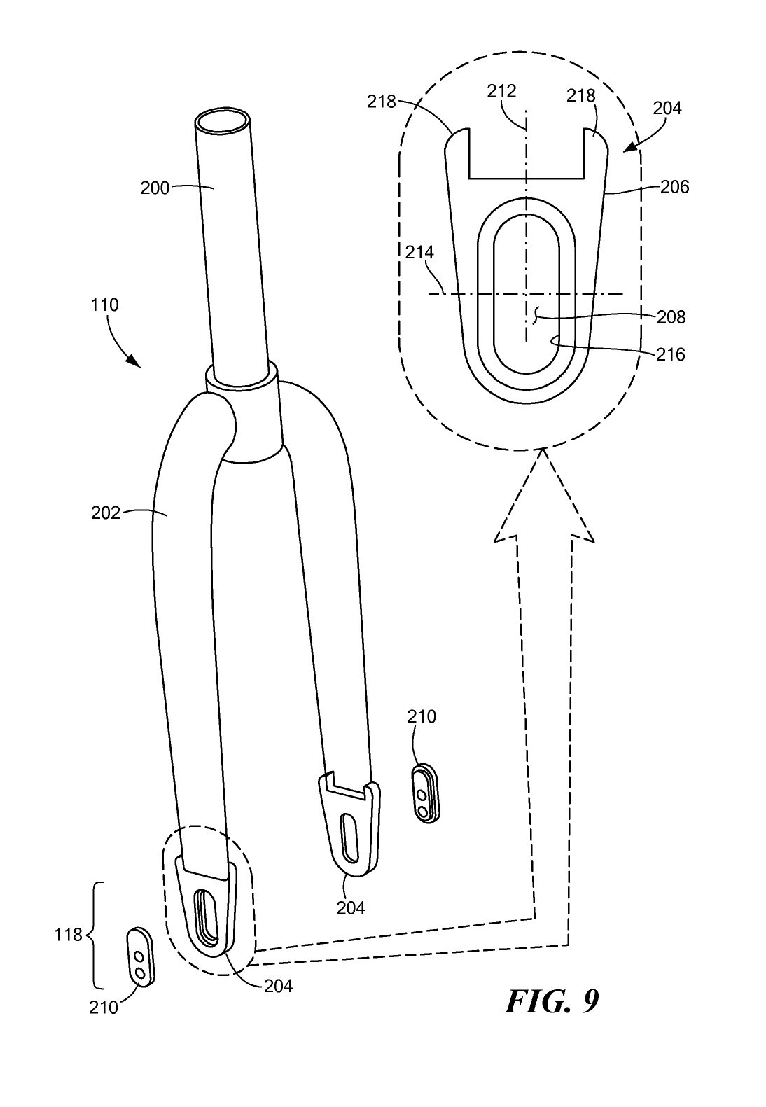

While the aforementioned discussion has focused on an insert 138, 168 suitable for a rear dropout arrangement, the scope of the invention also extends to an insert suitable for a front fork dropout arrangement, which will now be discussed with reference to FIGS. 9-12.

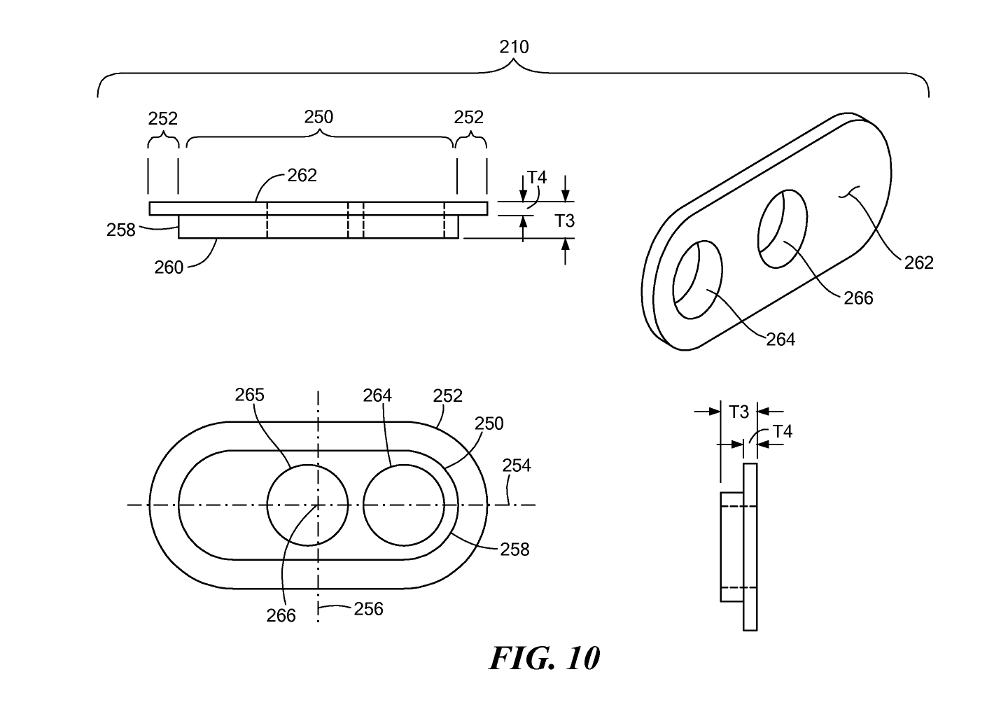

FIG. 9 depicts a front fork 110 having a steerer tube 200 that is pivotally supported by the head tube 108, and a pair of front forks 202 that straddle the front wheel 116 and include front wheel mounts 118. As discussed above, the pair of front forks 202 may in fact consist of only one “fork”, which is referred to as a “left-single-sided-fork” or a “right-single-sided-fork” depending on which side of the front wheel 116 the one “fork” is positioned. FIG. 2 illustrates a “left-single-sided-fork” arrangement. The discussion provided herein with respect to the front wheel mount 118 applies to any front “fork” arrangement that may be contemplated in the art. The front wheel mount 118 includes a mounting plate (alternatively front dropout) 204 having a body 206 with an elongated opening 208. While the term “front dropout” is typically employed in the bicycle art, it will be appreciated from the description herein that the front wheel 116 does not “dropout” per se with the loosening of front axle hardware, but rather is held in place with one-degree-of-freedom by an insert 210, which is discussed further below. The elongated opening 208 is surrounded around its entire perimeter by a constraining surface 216 of the body 206, and is symmetrically arranged with respect to a major datum line 212 and a minor datum line 214, as illustrated in FIG. 9. The elongated opening 208 functions similarly to the elongated opening 130 discussed above in connection with the rear dropout. That is, the elongated opening 208 is configured to receive an elongated insert 210, discussed further below, in a first orientation or a second orientation rotated 180-degrees relative to the first orientation, thereby providing for height adjustment of the front fork 110 using inserts 210 having different hole configurations while constraining the insert 210 to have just one-degree-of-freedom (absent mounting/securing hardware), which will now be discussed with reference to FIG. 10.

FIG. 10 depicts an elongated insert 210 similar to the elongated insert 138 discussed above, but with a geometry that is tailored for a front fork application. Similar to the layout of FIG. 6, FIG. 10 depicts a single perspective view and three orthogonal views of an elongated insert 210. Similar to the overall geometry of elongated insert 138, elongated insert 210 includes a central portion 250 and an outer portion 252 that is contiguous with the central portion 250 to form a unitary elongated body, which is referred to by reference to reference numeral 210. Features of the body 210 are dimensionable by reference to a major datum line 254 and a minor datum line 256, and by reference to thicknesses T3, T4 of the central and outer portions 250, 252, respectively. The outer portion 252 forms a flange of the body 210 having a thickness T4, the outer profile of the flange being larger than the outer profile of the central portion 250. When comparing FIG. 10 with FIG. 9, the major and minor datum lines 254, 256 of the elongated insert 210 are aligned with the major and minor datum lines 212, 214 of the elongated opening 208 of the front wheel mount 118 when the insert 210 is disposed within the opening 208. The opening 208 of the mounting plate 204 may be stepped on an outboard surface so the flange 252 sits within the stepped area, or may not be stepped so the flange 252 sits proud of an outer surface of the mounting plate 204. An outer surface 258 of the central portion 250 is sized to fit snugly within and to be fixedly constrained in two dimensions (one-degree-of-freedom) by the constraining surface 216 surrounding the hole 208 of the mounting plat 204. When held in place by the hardware (illustrated generally in FIGS. 1, 2 and 3), the elongated insert 210 is constrained in three dimensions (zero-degree-of-freedom).

The body of the elongated insert 210 has a first outer surface 260 defined by the central portion 250, and a second opposing outer surface 262 defined by a combination of the central portion 250 and the outer portion 252. In an embodiment, the first outer surface 260 is planar and parallel with the second opposing outer surface 262, which is also planar. However, from the disclosure provided herein, it will be appreciated that while the first and second outer surfaces 260, 262 may be planar, they need not be planar, which will be discussed further below. The central portion 250 of the elongated insert 210 has a first through-hole 264 and a second through-hole 265 that each extend parallel to each other and perpendicularly through the body from the first outer surface 260 to the second outer surface 262. The center of each through-hole 264, 265, with respect to the major and minor datum lines 254, 256, define hole axes, where one of the axes may or may not coincide with the intersection 266 of the major and minor datum lines 254, 256, which will be discussed further below. As illustrated in FIG. 10, the hole axis of second through-hole 265 is visually illustrated so that it does not coincide with the intersection 266. As illustrated in FIG. 10, the central portion 250 of the elongated insert 210 has a non-circular oval-like outer profile that encloses both hole axes of the first and second through-holes 264, 265, and the flange 252 has a non-circular oval-like outer profile that encloses both the hole axes of the first and second through-holes 264, 265. As further illustrated in FIG. 10, the central portion 250 of the elongated insert 210 is thicker than the outer portion (flange) 252. The central portion 250, as discussed herein, is used to position each through-hole 264, 265 relative to the mounting plate 204 when the central portion 250 of the elongated insert 210 is disposed within the elongated opening 208 of the mounting plate 204.

The major datum line 212 of the mounting plate 204 is oriented lengthwise with the length of the elongated opening 208, and the minor datum line 214 of the mounting plate 204 is oriented widthwise with the width of the elongated opening 208. The major datum line 212 is oriented perpendicular with the minor datum line 214. In contrast with the elongated opening 130 of the rear dropout, the major datum line 212 and lengthwise orientation of the elongated opening 208 of the fork dropout are oriented more vertical than horizontal with respect to a line of force of gravity 136 when the bicycle 100 is oriented for riding on a horizontal ground plane 128, which can be seen with reference to FIGS. 1, 2, 3 and 9 in combination. Such an arrangement provides for height adjustment of the axis of the front wheel 116 by changing out or rotating inserts 210, which in turn provides for adjustment of the angle of the head tube 108 and the height of the bottom bracket shell 146.

As will be appreciated from the foregoing description, elongated inserts 138 (rear dropout) and 210 (fork dropout) share many common structural features. As such, it is contemplated that features illustrated for one but not the other may equally apply to the other. For example, insert 138 is depicted having a single through-hole 164, while insert 210 is depicted having two through-holes 264, 265. As such, it is contemplated that insert 138 may also be constructed having more than one through-hole. Furthermore, insert 138 is described with reference to Table-1 that tabulates various locations for through-hole 164 relative to an end-edge of central portion 150, while insert 210 is not so described. As such, it is contemplated that insert 210 may also be constructed with reference to a table similar to Table-1 that positions one or more of through-holes 264, 265 relative to an end-edge of central portion 250.

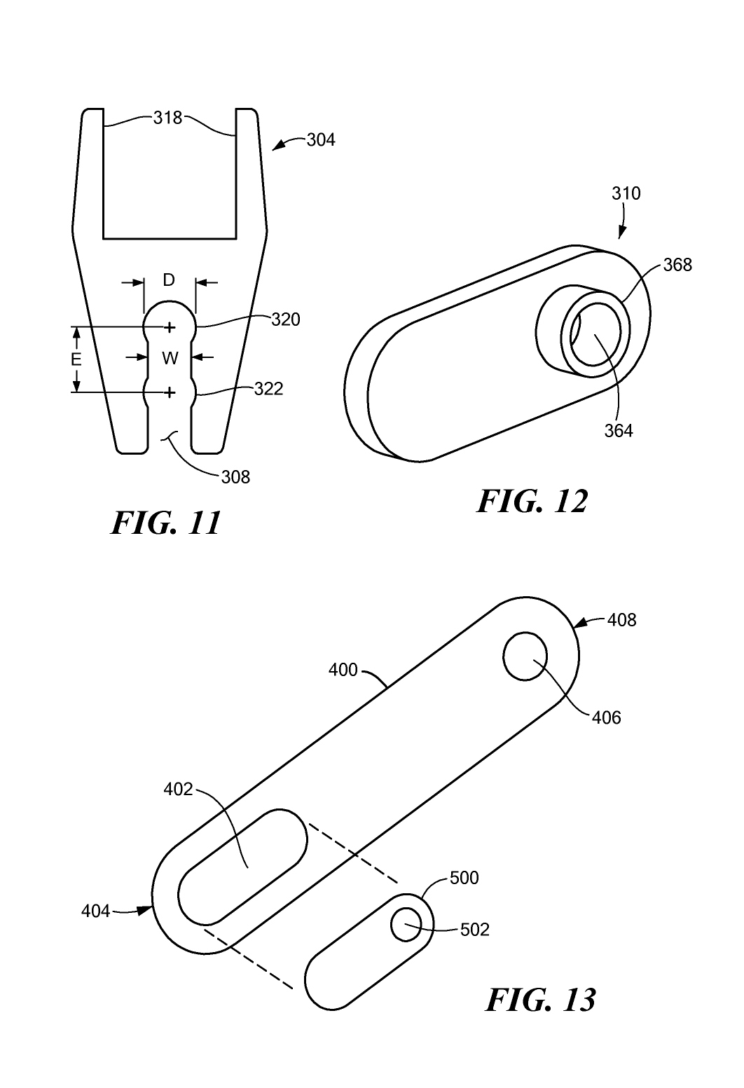

Reference is now made to FIG. 11, which depicts a mounting plate/dropout 304 similar to mounting plate/dropout 204, but with an open-ended elongated opening 308 sized to receive an elongated insert 310, which is best seen with reference to FIG. 12. The fingers 318 of mounting plate 304 are similar to the fingers 218 of mounting plate 204, where each set of fingers are used to positionally attach the respective mounting plate to the lower end of the pair of forks 202 (as depicted in FIG. 9), which in an embodiment are fixedly attached using a welding process. As illustrated in FIG. 11, the inside profile of the elongated opening 308 includes two rounded portions 320, 322, with each rounded portion having a profile dimension “D” greater than a narrower profile dimension “W” of the opening 308.

With reference to FIG. 12, the elongated insert 310 includes a through-hole 364 surrounded by a boss 368. The boss 368 is sized to fit within the profile dimension “D” but not within the profile dimension “W”, thereby providing for two-dimensional constraint (one-degree-of-freedom) of the insert 310 when the insert 310 is attached to the mounting plate 304. Mounting hardware (generally depicted in FIGS. 1, 2 and 3) used to secure the front wheel 116 to the front fork 110 via the through-hole 364 of the insert 310 provides for constraint of the insert 310 in a third dimension (zero-degree-of-freedom). As illustrated in FIG. 12, the through-hole 364 and boss 368 are biased to one end of the insert 310. The center-to-center distance “E” of the two rounded portions 320, 322 is sized such that the insert 310 may be oriented in a first orientation with the boss 368 constrained by the first rounded portion 320, and may be oriented in a second orientation 180-degrees rotated with respect to the first orientation with the boss 368 constrained by the second rounded portion 322. Such an arrangement provides for height adjustment of the axis of the front wheel 116 by rotating insert 310, which in turn provides for adjustment of the angle of the head tube 108 and the height of the bottom bracket shell 146.

While not specifically described, other features may be common between insert 310 and inserts 138 and 210, which are considered within the scope of the invention by reference to the foregoing descriptions of inserts 138 and 210 and the several figures provided herewith.

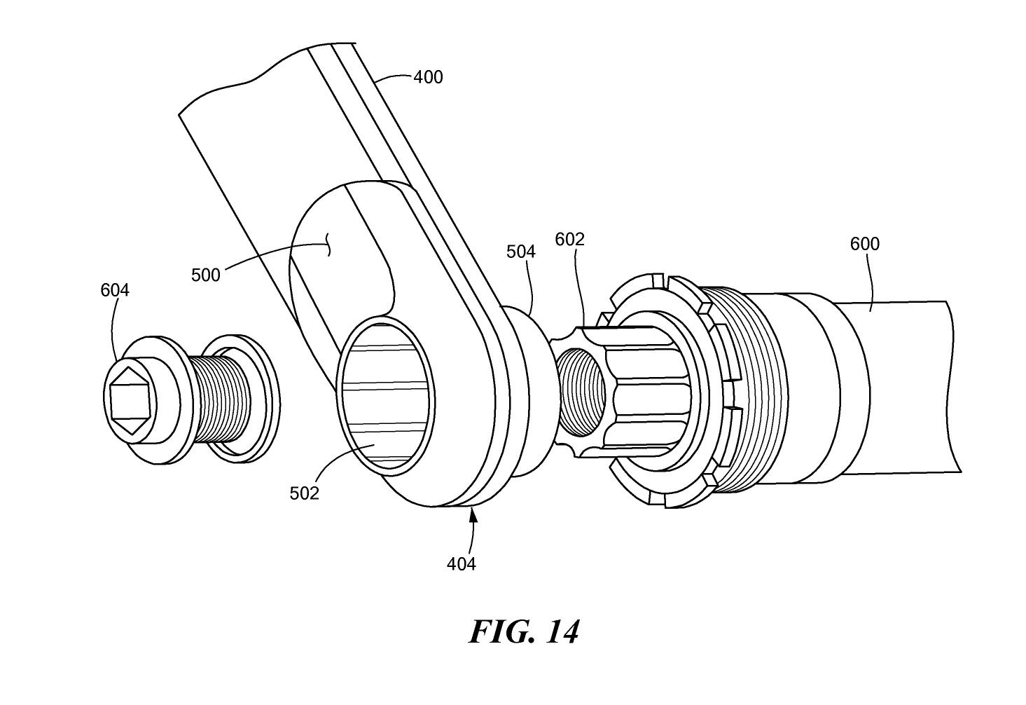

It will be appreciated from the foregoing description that elongated inserts 138 (rear dropout), 210 (fork dropout), and 310 (alternate fork dropout) share many common structural features. As such, it is contemplated that other inserts in other structural members of a bicycle 100 may be equally usable in providing adjustability of a functional characteristic of the associated structural member of the bicycle 100, such as for example, for providing adjustability in the length of a crank arm, which will now be discussed in connection with FIGS. 13 and 14.

FIG. 13 depicts in block diagram form a bicycle crank arm 400 having an elongated opening 402 disposed at a first end 404 of the crank arm 400 and a pedal spindle opening 406 disposed at a second opposing end 408 of the crank arm 400, and an elongated insert 500 having a through-hole 502 biased toward one end of the elongated insert 500. The pedal spindle opening 406 is configured to pivotally support a pedal (generally illustrated in FIGS. 1, 2 and 3). The elongated opening 402 is sized to receive the elongated insert 500 in a manner discussed above in connection with inserts 138, 210 and 310. That is, insert 500 may be placed in opening 402 in a first orientation and in a second orientation that is rotated 180-degrees relative to the first orientation about a central axis of through-hole 502. By providing such an insert arrangement, the offset through-hole 502, which is used to fixedly mount the crank arm 400 to a crank spindle (best seen with reference to FIG. 14), may be located in a first orientation closer to the first end 404 of crank arm 400, or may be located in a second orientation closer to the second end 408 of crank arm 400, thereby providing adjustability in the functional length of the crank arm 400.

FIG. 14 depicts a more detailed perspective view of the elongated insert 500 attached to the crank arm 400 with the through-hole 505 of the insert 500 disposed in the first orientation closer to the first end 404 of the crank arm 400. The insert 500 includes an engagement portion 504 that engages with splines 602 of crank spindle 600 to provide a means for transferring torque from the crank arm 400 to the drive chain 148. The crank spindle 600 is pivotally disposed within the bottom bracket shell 146, which is best seen by also referencing bicycle 100 and frame 102 of FIGS. 1, 2, 3 and 4. Positioning of the elongated insert 500 within the elongated opening 402 constrains the insert in two orthogonal dimensions in a manner similar to that described above. Hardware 604 is used to provide final securement of the insert 500 and crank arm 400 to the spindle 600, thereby further constraining the insert 500 in a third orthogonal dimension along the axis of the spindle 600 to produce constraint with zero-degree-of-freedom.

From all of the foregoing description and illustration, it will be understood that an elongated insert may be employed in at least one of a rear dropout, a fork dropout, and a crank arm, to provide for adjustability of a functional characteristic of a bicycle 100 that is consistent with the description provided herein.

While certain combinations of features relating to a bicycle have been described herein, it will be appreciated that these certain combinations are for illustration purposes only and that any combination of any of these features may be employed, explicitly or equivalently, either individually or in combination with any other of the features disclosed herein, in any combination, and all in accordance with an embodiment of the invention. Any and all such combinations are contemplated herein and are considered within the scope of the invention disclosed.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the scope of the appended claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

1-14. (canceled)

15. A bicycle and a collection of adjusters in combination, comprising:
a frame comprising a front portion and a rear portion attached to the front portion, the front portion comprising a head tube, and the rear portion comprising a rear wheel mount;
a front fork pivotally supported by the head tube, the front fork comprising a front wheel mount;
wherein at least one of the rear wheel mount and the front wheel mount comprises an elongated opening, the elongated opening being enclosed around its perimeter by a constraining surface, the elongated opening being dimensionable by reference to at least a major datum line and a minor datum line;
wherein the major datum line of the rear wheel mount is oriented more horizontal than vertical with respect to a line of force of gravity when the portion of the bicycle is oriented for riding, and the major datum line of the front wheel mount is oriented more vertical than horizontal with respect to a line of force of gravity when the portion of the bicycle is oriented for riding; and
a collection of adjusters comprising:
a plurality of insert members, each insert member sized to be removably received in the elongated opening and configured to be exchanged with another of the plurality of insert members by an end user, the each plurality of insert members comprising:
a central portion and an outer portion that is contiguous with the central portion to form a unitary elongated member, the body being dimensionable by reference to at least the major datum line and the minor datum line, the outer portion forming a flange;
wherein the body comprises a first outer surface defined by the central portion, and a second opposing outer surface defined by the central portion and the outer portion;
wherein the central portion comprises a through-hole that extends perpendicularly through the body from the first outer surface to the second outer surface, wherein the hole defines a hole axis, the hole axis being offset a distance from an;
wherein the central portion has a non-circular outer profile that encloses the hole axis, and the flange has a non-circular outer profile that encloses the hole axis, the outer profile of the flange being larger than the outer profile of the central portion;
wherein the hole is disposed offset a distance with respect to the minor datum line, wherein the distance for each of the plurality of insert members being different.

16. The bicycle and a collection of adjusters in combination of claim 15, wherein the major datum line is centrally disposed in a first orientation with respect to a plan view profile of the body, and the minor datum line is centrally disposed in a second orientation perpendicular to the first orientation with respect to the plan view profile of the body.

17. The bicycle and a collection of adjusters in combination of claim 15, wherein:
the hole comprises a first hole; and
the central portion further comprises a second hole that extends perpendicularly through the body from the first outer surface to the second outer surface, the second hole being disposed offset from and parallel to the first hole.

18. The insert of claim 17, wherein both the first hole and the second hole are disposed on the major datum line.

19. The bicycle and a collection of adjusters in combination of claim 18 wherein the elongated opening is arranged in the front wheel mount.

20. The bicycle and a collection of adjusters in combination of claim 15 wherein the elongated opening is arranged in the rear wheel mount.

21. The bicycle and a collection of adjusters in combination of claim 19 further comprising:
a single sprocket operably coupled to the rear wheel mount;
a chain ring operably coupled to the frame; and
a drive chain directly coupling the single sprocket to the chain ring.
